(19) United States
(12) Patent Application Publication
(10) Pub. No.: US 2023/0199421 A1
(43) Pub. Date: Jun. 22, 2023

(54) AUDIO PROCESSING METHOD AND APPARATUS, AND STORAGE MEDIUM

(71) Applicant: Beijing Baidu Netcom Science Technology Co., Ltd., Beijing (CN)

(72) Inventors: Rui Qing, Beijing (CN); Jianqiang WEI, Beijing (CN)

(21) Appl. No.: 17/893,907

(22) Filed: Aug. 23, 2022

(30) Foreign Application Priority Data
Dec. 21, 2021 (CN) 202111572486.2

(51) Int. Cl. H04S 7/00; H04S 1/00

(52) U.S. Cl. CPC H04S 7/303; H04S 7/305; H04S 1/007; H04S 2420/01; H04S 2400/15; H04S 2400/11

(57) ABSTRACT

Provided are an audio processing method and apparatus, and a storage medium, which relate to the technical field of artificial intelligence and, in particular, to the speech technical field. The specific implementation solution is as follows. In response to receiving to-be-processed audio, a target sounding direction corresponding to the to-be-processed audio is determined; direction sense reconstruction is performed on the to-be-processed audio according to a direction sense reconstruction filter corresponding to the target sounding direction to obtain target audio; and the target audio is output.

### CROSS-REFERENCE TO RELATED APPLICATION

This application claims priority to Chinese Patent Application No. CN202111572486.2, filed on Dec. 21, 2021, the disclosure of which is incorporated herein by reference in its entirety.

### TECHNICAL FIELD

The present disclosure relates to the technical field of artificial intelligence, in particular, to the speech technical field, and specifically, to an audio processing method and apparatus, a device and a storage medium.

### BACKGROUND

With the rapid development of the Internet, increasing social activities are held online, providing convenience for users. Online communication is used by more and more users as a novel communication manner. The images and the voices of participants are fed back to users via peripheral devices, so that the users can acquire information from the online communication.

### SUMMARY

The present disclosure provides an audio processing method and apparatus, a device and a storage medium.

According to an aspect of the present disclosure, an audio processing method is provided and includes steps described below.

In response to receiving to-be-processed audio, a target sounding direction corresponding to the to-be-processed audio is determined.

Direction sense reconstruction is performed on the to-be-processed audio according to a direction sense reconstruction filter corresponding to the target sounding direction to obtain target audio.

The target audio is output.

According to another aspect of the present disclosure, an electronic device is provided.

The electronic device includes at least one processor and a memory communicatively connected to the at least one processor.

The memory stores instructions executable by the at least one processor, and the instructions are executed by the at least one processor to cause the at least one processor to execute any audio processing method provided by the embodiments of the present disclosure.

According to another aspect of the present disclosure, a non-transitory computer-readable storage medium is provided. The storage medium is configured to store computer instructions for causing a computer to execute any audio processing method provided by the embodiments of the present disclosure.

According to the embodiments of the present disclosure, immersive online communication experience is provided for online participants.

It is to be understood that the content described in this part is neither intended to identify key or important features of the embodiments of the present disclosure nor intended to limit the scope of the present disclosure. Other features of the present disclosure are easily understandable from the description provided hereinafter.

### BRIEF DESCRIPTION OF DRAWINGS

The drawings are intended to provide a better understanding of the solution and not to limit the present disclosure.

FIG. 1 is a diagram of an audio processing method according to an embodiment of the present disclosure;

FIG. 2 is a diagram of another audio processing method according to an embodiment of the present disclosure;

FIG. 3 is a diagram of another audio processing method according to an embodiment of the present disclosure;

FIG. 4A is a diagram of another audio processing method according to an embodiment of the present disclosure;

FIG. 4B is a comparison diagram of space sense test results according to an embodiment of the present disclosure;

FIG. 4C is a comparison diagram of personal preference test results according to an embodiment of the present disclosure;

FIG. 4D is a diagram showing the tone quality spectrum before a cache manner is used and the tone quality spectrum after the cache manner is used in a mode switching condition according to an embodiment of the present disclosure;

FIG. 5 is a diagram illustrating the structure of an audio processing apparatus according to an embodiment of the present disclosure; and

FIG. 6 is a block diagram of an electronic device for implementing an audio processing method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

Various audio processing methods and audio processing apparatuses provided in the present disclosure are applicable to performing processing on audio of participants in a case of online communication (such as online meetings or group chats). Various audio processing methods provided in the present disclosure may be executed by an audio processing apparatus. The audio processing apparatus may be implemented by hardware and/or software and may be configured in an electronic device.

To facilitate understanding, various audio processing methods are described in detail first.

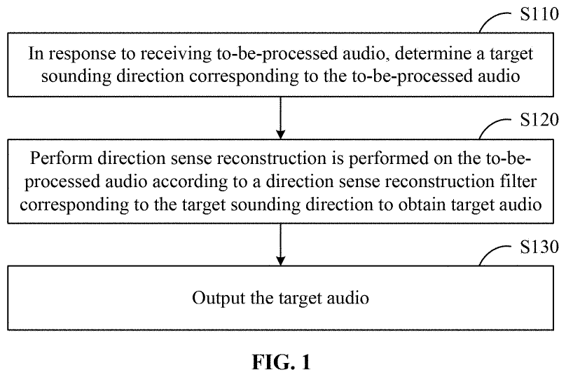

The audio processing method shown in FIG. 1 includes steps described below.

In S110, in response to receiving to-be-processed audio, a target sounding direction corresponding to the to-be-processed audio is determined.

The to-be-processed audio may be to-be-processed audio of a target participant. The target participant may be a login account or a device that participates in online communication. The to-be-processed audio may be audio information output by the target participant during the communication. The target sounding direction may be a simulated sound source direction assigned to the target participant during the online communication. The to-be-processed audio, the target participant and the target sounding direction have a corresponding relationship, which is generally a one-to-one corresponding relationship.

Exemplarily, in practical situations, to enable other participants than the target participant to perceive the position of the target participant in the online communication process, the to-be-processed audio of the target participant is assigned a simulated sound source direction after being received. Whether to-be-processed audio containing human voices is received can be determined according to the energy of the audio, and then the target participant corresponding to the to-be-processed audio is determined. Since the energy of different sounds is different, recognizable sound information may be filtered by setting an energy threshold of sounds. For example, background noise is filtered out, and then the audio information containing human voices may be used as the to-be-processed audio for subsequent processing.

In S120, direction sense reconstruction is performed on the to-be-processed audio according to a direction sense reconstruction filter corresponding to the target sounding direction to obtain target audio.

The direction sense reconstruction filter may be a filter for performing the filtering process on the to-be-processed audio of the target participant. The filter may be implemented by software and/or hardware, for example, may be a head-related transfer function (HRTF) filter. The target audio may be audio information that assigns a direction sense to the to-be-processed audio.

The HRTF simulates the transmission process of sound waves from a sound source to two ears. This transmission process is the result of integrated filtering of sound waves by human physiological structures (such as the head, the pinnae and the trunk). Since the HRTF contains information related to sound source positioning, the HRTF may be used for performing direction sense reconstruction on the sounds. In practical applications, a variety of spatial auditory effects can be simulated by playing sound signals processed by the HRTF with headphones or speakers.

Exemplarily, after the sounding direction of the target participant is determined, filtering may be performed on the to-be-processed audio of the target participant to assign the direction sense to the to-be-processed audio, so as to obtain the audio information after the direction sense reconstruction.

In S130, the target audio is output.

Exemplarily, the target audio may be output to various participants who participate in the online communication. Generally, it is only necessary to output the target audio to other participants, so as to reduce the unnecessary waste of transmission resources.

The other participants may be participants other than the target participant among the participants participating in the online communication. After the target audio information subjected to the direction sense reconstruction is obtained, the target audio having the direction sense information is sent to other participants for listening.

In the technical solution of the embodiment of the present disclosure, the sounding direction of the target participant is determined, and then the direction sense reconstruction is performed on the audio, so that the target audio heard by other participants has the direction sense. Therefore, the effect of simulating offline communication is achieved, and the immersive online communication experience is improved.

The preceding audio processing method requires the determination of the target sounding direction and the direction sense reconstruction, leading to a certain delay and memory resource occupation in the audio output process. For users to autonomously select whether to experience immersive communication, talk modes including an immersive mode and a normal mode may be preset for selection.

Exemplarily, if the immersive mode is selected, an audio output mechanism in the immersive mode is used. In this mode, various audio processing methods provided by the present disclosure are used for converting the to-be-processed audio of the target participant into the target audio as to-be-output audio for output. If the normal mode is used, an audio output mechanism in the normal mode is used. In this mode, the to-be-processed audio of the target participant is directly taken as to-be-output audio for output.

In practical use, mode switching may be performed, that is, switching from the immersive mode to the normal mode or switching from the normal mode to the immersive mode may be performed. Due to the inherent delay of the immersive mode, audio lagging may occur in the switching process, affecting the online communication experience.

In an optional implementation, the to-be-output audio may be cached in a preset cache region, where the to-be-output audio is the target audio in the immersive mode or the to-be-processed audio in the normal mode; and in response to a mode switching operation, the to-be-output audio in the preset cache region is output.

The preset cache region may be a storage region for temporarily storing the to-be-output audio.

Exemplarily, during the online communication process, the switching between the immersive mode and the normal mode may be performed to cope with different situations. During the communication, the to-be-output audio may be stored in the preset cache region. When the audio is output, the audio information in the preset cache region may be output first. When mode switching is required, the audio information in the preset cache region may be output first for audio transition. After the mode switching is completed, the talk mode after switching may be used for audio output.

For example, when the current talk mode is the normal mode, the audio output mechanism in the normal mode may be used, and thus the to-be-processed audio of the target participant is directly output; and when the to-be-processed audio is received, the to-be-processed audio is cached as the to-be-output audio in the preset cache region. In response to the mode switching operation from the normal mode to the immersive mode, the to-be-output audio in the preset cache region is continuously output first, and then after the output of the to-be-output audio in the preset cache region is completed, an audio processing mechanism in the immersive mode is used for outputting the target audio. To cope with the subsequent switching from the immersive mode to the normal mode, the target audio after the direction sense reconstruction may be cached in the preset cache region as new to-be-output audio.

For another example, when the current talk mode is the immersive mode, the audio output mechanism in the immersive mode may be used, and the to-be-processed audio of the target participant is converted into the target audio for output. After the target audio is generated, the target audio is cached as the to-be-output audio in the preset cache region. In response to the mode switching operation from the immersive mode to the normal mode, the to-be-output audio in the preset cache region is continuously output first, and then after the output of the to-be-output audio in the preset cache region is completed, an audio processing mechanism in the normal mode is used for outputting the to-be-processed audio. To cope with the subsequent switching from the normal mode to the immersive mode, after the to-be-processed audio is received, the to-be-processed audio may further be cached in the preset cache region as new to-be-output audio.

According to the technical solution of the preceding implementation, the preset cache region is introduced to cache the to-be-output audio, and the to-be-output audio in the preset cache region is output when the mode switching is performed, thereby achieving the smooth transition of the audio output during the mode switching process, effectively solving the problem of audio lagging caused by the mode switching, providing smooth audio connection and output for the mode switching process, and improving the auditory experience of the participants.

In an optional implementation, before the target audio is output, room reverberation may further be performed on the target audio to update the target audio. Correspondingly, the updated target audio is output.

The room reverberation can simulate the phenomenon that sound wave energy gradually attenuates due to being absorbed by the diffuse reflection surface when sound waves are reflected back and forth in various directions and attenuate gradually. The room reverberation may be implemented by software and/or hardware. For example, reverberation signals may be added to the target audio through a preset feedback delay network, which may use any one of feedback delay networks (FDN) known in the related art.

Exemplarily, a feedback delay is applied to the information of the target audio before the target audio is output to add the reverberation signals, so as to create a sound reverberation effect and further enhance the simulation effect of sound propagation in the room. For example, the FDN is used for processing the target audio, that is, reverberation simulation is performed for rooms of different sizes by presetting different delay levels of the FDN. The delay level may be determined based on the experience of those skilled in the art or through a large number of trials. Generally, the greater the number of people a room accommodates, that is, the larger the room area desired to be simulated, the higher the delay level.

According to the technical solution of the preceding implementation, the feedback delay network is used for performing reverberation on the to-be-output target audio, achieving the effect of simulating human voice propagation in a real room, and further improving the immersive communication experience of participants.

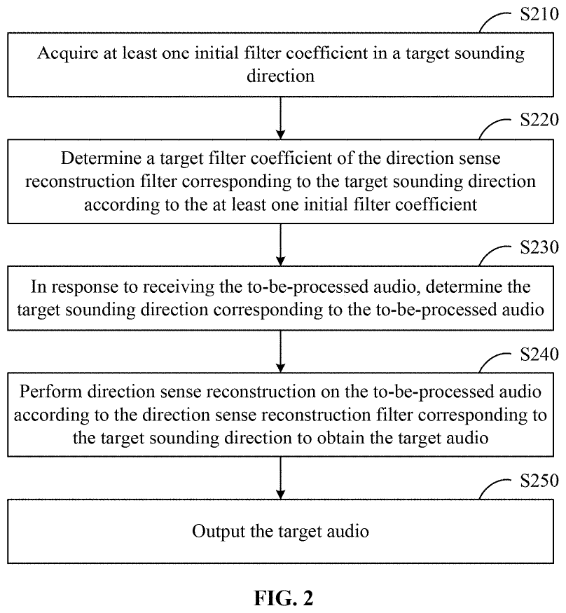

FIG. 2 is a diagram of another audio processing method according to an embodiment of the present disclosure. The embodiment supplements the preceding embodiment with the determination operation of a target filter coefficient involves in the direction sense reconstruction filter. The target filter coefficient may be a filter parameter used when the direction sense reconstruction filter performs direction sense reconstruction for the to-be-processed audio. It is to be noted that for the part not detailed in the embodiment of the present disclosure, reference may be made to related expressions of other embodiments.

The audio processing method shown in FIG. 2 includes steps described below.

In S210, at least one initial filter coefficient in a target sounding direction is acquired.

The initial filter coefficient may be a filter coefficient for reference in the open-source database of a direction sense reconstruction filter.

It is to be noted that the open-source database stores filter coefficients obtained from perception tests of sounds in different directions for different human head structures. At least one filter coefficient for perceiving sounds in a certain preset sounding direction is selected from the filter coefficients obtained in these tests as the initial filter coefficient. It is to be understood that the same human head structure, in different sounding directions, generally corresponds to different filter coefficients in the open-source database, which represents the difference of direction sense reconstruction in different sounding directions; different human head structures, in the same sounding direction, generally correspond to different filter coefficients in the open-source database, which represents the difference of direction sense perception by different human head structures.

In S220, a target filter coefficient of the direction sense reconstruction filter corresponding to the target sounding direction is determined according to the at least one initial filter coefficient.

The target filter coefficient corresponding to the target sounding direction is a filter coefficient for performing direction sense reconstruction on to-be-processed audio of a target participant. The at least one initial filter coefficient acquired form the open-source database is calculated to obtain the target filter coefficient for use. The calculation manner may be a random selection manner or a weighted mean manner. It is to be understood that the target filter coefficient obtained in the weighted mean manner conforms to the perception of most types of human head structures on sounding directions, and thus has the universal applicability. The weight value used in the weighted mean manner is not limited in the present disclosure. For example, different initial filter coefficients may correspond to the same weight, and it is only necessary to ensure that the sum of the weight values is 1.

In an optional implementation, the step in which the target filter coefficient is determined according to the at least one initial filter coefficient may include steps described below. The at least one initial filter coefficient is weighted to obtain a reference filter coefficient; and the target filter coefficient is determined according to the reference filter coefficient.

The reference filter coefficient is a filter coefficient obtained by performing the weighting calculation on the at least one initial filter coefficient. Optionally, the weighting may be in the form of the weighted mean, that is, all the initial filter coefficients participating in the weighting have the same weight, and then the reference filter coefficient having the universal applicability can be calculated.

Optionally, the reference filter coefficient may be directly taken as the target filter coefficient for use.

However, some information may be lost after the audio data is processed by the direction sense reconstruction filter constructed directly based on the reference filter coefficient, affecting the auditory experience of users. To avoid the preceding situation due to the unreasonableness of some reference filter coefficients, the reference filter coefficient may be adjusted numerically.

In a specific implementation, the reference filter coefficient may be adjusted according to standard spectral data of a direction sense reconstruction filter. Alternatively, the at least one initial filter coefficient may be input into a pre-trained target filter coefficient calculation model to output a to-be-used target filter coefficient. The target filter coefficient calculation model may be implemented using at least one related machine learning model, and the present disclosure does not limit the specific model structure.

In an optional implementation, the step in which the target filter coefficient is determined according to the reference filter coefficient may include the step described below. The reference filter coefficient is adjusted according to spectral data of the direction sense reconstruction filter corresponding to the reference filter coefficient to obtain the target filter coefficient.

The spectral data refers to the distribution curve of the sound frequency to characterize the density of the frequency spectrum. The same sound information emitted from different directions has different spectral data. Thus, the spectral data of direction sense reconstruction filters in different directions is different. After being calculated, the reference filter coefficient is adjusted according to the spectral data of the corresponding direction sense reconstruction filter and based on the standard spectral data obtained in advance through statistics, so as to obtain the target filter coefficient. For example, the gain of each frequency band signal may be adjusted by an Equalizer (EQ), that is, an audio equalizer, so that the reference filter coefficient corresponds to a sound frequency higher than the spectral data is adjusted towards a reference filter coefficient corresponding to a low sound frequency, and the reference filter coefficient corresponds to a sound frequency lower than the spectral data is adjusted to be high towards a reference filter coefficient corresponding to a high sound frequency.

According to the technical solution of the preceding implementation, the reference filter coefficient is adjusted according to the spectral data, so that audio distortion due to the unreasonable reference filter coefficient is avoided when the sounding direction is reconstructed according to the obtained target filter coefficient, the reasonability of the target filter coefficient is improved, the smoothness and fidelity of target audio is ensured, and the tone quality of the subsequent target audio is improved.

In the embodiment of the present disclosure, weighted fusion is performed on the at least one initial filter coefficient in the target sounding direction to assist in the determination of the target filter coefficient, so that the target filter fuses differences carried by different initial filter coefficients, for example, differences of human head structures and differences of recording environments corresponding to the initial filter coefficients. Therefore, the determined target filter coefficient is more universal, and the effect of auditory differences of different people is weakened.

In S230, in response to receiving the to-be-processed audio, the target sounding direction corresponding to the to-be-processed audio is determined.

In S240, direction sense reconstruction is performed on the to-be-processed audio according to the direction sense reconstruction filter corresponding to the target sounding direction to obtain the target audio.

In S250, the target audio is output.

It is to be noted that S210 to S220 may be executed before, after, or in parallel or alternation with S230, and the present disclosure does not limit the specific execution order of S210 to S220 and S230, but only ensures that S210 to S220 are executed before S240.

According to the technical solution of the embodiment of the present disclosure, the at least one initial filter coefficient is processed to obtained the target filter coefficient having a better effect for direction sense reconstruction, so that the determination mechanism of the target filter coefficient is improved. The at least one initial filter coefficient in the target sounding direction is introduced to determine the target filter coefficient, so that the impact of differences of human head structures and differences of recording environments can be reduced according to the target filter coefficient, and the universality of the target filter coefficient is improved.

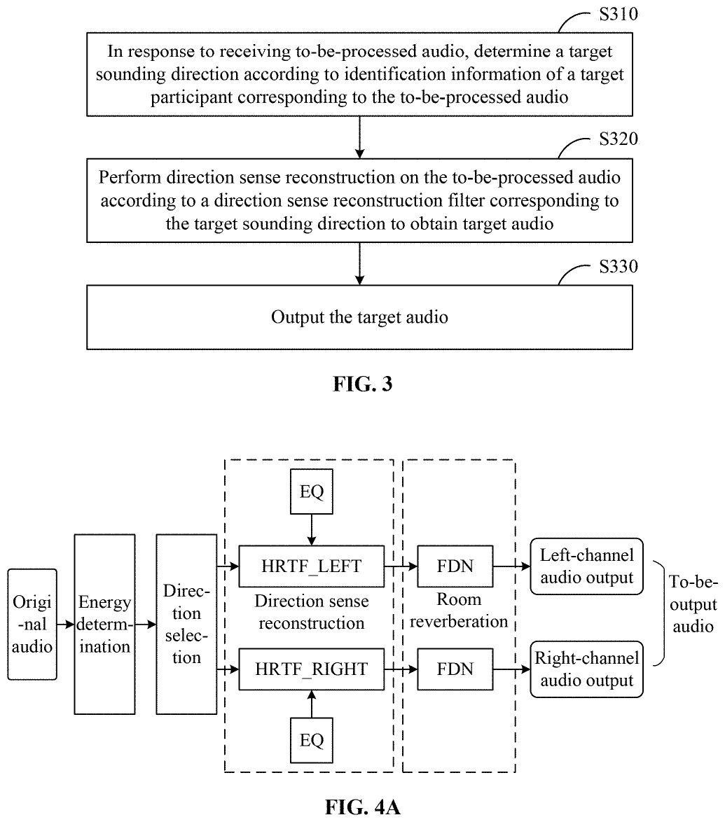

FIG. 3 is a diagram of another audio processing method according to an embodiment of the present disclosure. The embodiment specifies the determination operation of the target sounding direction based on the preceding embodiments. It is to be noted that for the part not detailed in the embodiment of the present disclosure, reference may be made to related expressions of other embodiments.

Referring to FIG. 3, the audio processing method provided in the embodiment includes steps described below.

In S310, in response to receiving to-be-processed audio, a target sounding direction is determined according to identification information of a target participant corresponding to the to-be-processed audio.

The identification information of the target participant is used for uniquely characterizing the identity information of the target participant, and different participants have different identification information. For example, an Identity (ID) may be selected as the identification information.

Exemplarily, when sound information is acquired, whether the sound is a human voice can be determined according to the energy of the sound. If the sound is a human voice, which participant is outputting the audio is determined according to identification information of the corresponding participant. After the target participant is determined, the target sounding direction is determined for the target participant.

In an optional implementation, the step in which the target sounding direction of the target participant is determined according to the identification information of the target participant may include steps described below. Whether the target participant is allocated a sounding direction is determined according to the identification information of the target participant; and in a case where the target participant is not allocated a sounding direction, the target sounding direction is allocated to the target participant according to an existence condition of at least one to-be-allocated sounding direction.

The existence condition of the to-be-allocated sounding direction may refer to whether a sounding direction available for allocation exists currently.

Exemplarily, identification information of the participant who is previously allocated a direction may be recorded when sounding directions are allocated. Therefore, whether the target participant is allocated a sounding direction can be known through the identification information of the target participant. If the identification information of the target participant shows that the target participant is not allocated a direction, the target participant may be allocated a sounding direction according to the current sounding direction available for allocation. Further, if the identification information of the target participant shows that the target participant is pre-allocated a sounding direction, the pre-allocated sounding direction is taken as the target sounding direction of the target participant.

The allocation order of the sounding directions may be determined according to the participation order of the participants, that is, the order in which the participants participate in the online communication; for example, the participant first entering the communication group (for example, accessing the online meeting) is preferentially assigned a sounding direction. Alternatively, the allocation order of the sounding directions may be determined according to the speaking order of the participants; for example, the participant who first outputs audio is preferentially assigned a sounding direction. Alternatively, different sounding directions may be allocated to the participants who enter the communication according to the order of initial letters of the identification information of the participants.

In practical situations, sounds may be from any direction of the listener. In terms of the plane, specific directions may be obtained by dividing the range of 360°. For example, every 60° is taken as a direction, and then 360° can be divided into six directions. The participant to whom the sounding direction is first assigned may occupy the middle direction, and then the participants to whom sounding directions are assigned later may be allocated directions one by one clockwise, or may be allocated directions through a left-right symmetrical manner. The method for allocating the sounding directions is not limited in the embodiment of the present disclosure.

According to the technical solution of the preceding implementation, whether the target participant corresponding to the to-be-processed audio is allocated a sounding direction is determined according to the identification information of the target participant, and the target participant is allocated the target sounding direction only if the target participant is not allocated a sounding direction, so that the illusion that the target participant moves generated due to different directions allocated to the same target participant is avoided, thus the auditory experience of other participants is improved, and the increase in the calculation amount caused by the repeated allocation of sounding directions is avoided.

In an optional implementation, the step in which the target sounding direction is allocated to the target participant according to the existence condition of the to-be-allocated sounding direction may include the step described below. In a case where no to-be-allocated sounding direction exists, the target sounding direction is selected from at least one allocated sounding direction according to the identification information of the target participant.

Exemplarily, if all the current sounding directions are allocated to participants, a sounding direction is selected from the sounding directions that have been allocated according to the identification information (such as the ID or the nickname) of the target participant and is assigned to the target participant, so as to achieve the multiplexing of the sounding direction. In this case, a sounding direction may be assigned to more than one participant.

For example, in practical situations, for the 360° in the plane, every 60° may be allocated a direction, so that a total of six directions are obtained, which may be marked as directions D₀ to D₅. After the current six participants are all allocated the corresponding directions D₀ to D₅, the seventh participant can only acquire a sounding direction from the six allocated directions D₀ to D₅ when being allocated a sounding direction. For example, in sequence, the seventh participant may be allocated direction D₀, the eighth participant may be allocated direction D₁, and so on.

In an optional implementation, the step in which the target sounding direction is selected from the allocated sounding direction according to the identification information of the target participant may include steps described below. A hash value of the identification information of the target participant is determined; numerical conversion is performed on the hash value to obtain allocation reference data; and identification information of the target sounding direction is determined according to the allocation reference data and the number of preset sounding directions.

The allocation reference data may be data information used as the reference or basis for sounding direction allocation. The identification information of the target sounding direction may be used for marking the target sounding direction. For example, the identification information of a target sounding direction may be 1, 2, 3 and 4, or may be east, south, west, north, etc. Exemplarily, hash calculation is performed on the identification information of the target participant, and numerical conversion may be performed on the obtained hash value to determine an exemplary numerical value, which may be used as the allocation reference data. This data value may be divided by the value of the number of preset sounding directions, and the obtained remainder is used as the identification information of the target sounding direction.

Following the preceding example, the preset sounding directions include D₀ to D₅, and the corresponding value of number is 6. It is assumed that the numerical value obtained by the numerical conversion on the hash value of the ID of the target participant is 9, the numerical value of the remainder obtained by dividing 9 by 6 is 3 and is taken as the identification information of the target sounding direction. That is, the target participant may be allocated sounding direction D₂ corresponding to numerical value 3.

According to the technical solution of the preceding implementation, in a case where no unallocated sounding direction exists, the identification information of the target participant is introduced to perform the allocation of the allocated sounding direction, so as to ensure that the same target participant is allocated the same allocated sounding direction when participating in communication again after leaving or dropping midway.

In the embodiment of the present disclosure, in a case where no to-be-allocated sounding direction exists, repeated allocation of the allocated sounding direction is performed, so that the multiplexing of the allocated sounding direction is achieved. In this manner, the case of a large number of participants is accommodated, and the universality of the audio processing method in the dimension of the number of participants is improved.

In an optional implementation, the step in which the target sounding direction is allocated to the target participant according to the existence condition of the to-be-allocated sounding direction may include the step described below. In a case where the at least one to-be-allocated sounding direction exists, the target sounding direction is selected from the at least one to-be-allocated sounding direction according to a rank of the target participant in a sounding order.

If the to-be-allocated sounding directions still exist currently, that is, the to-be-allocated sounding direction does not correspond to a participant, a direction is selected from the to-be-allocated sounding directions as the target sounding direction of the target participant. For example, if there are six preset sounding directions of which four have been allocated, one sounding direction is selected for the target participant from the remaining two directions.

According to the technical solution of the preceding implementation, in the case where the to-be-allocated sounding direction exists, the target sounding direction is allocated according to the rank of the target participant in the sounding order, so that the occurrence of missing allocation is avoided, unreasonable occupation of the sounding direction due to the sounding direction allocation for unsounded participants is avoided, and the utilization rate of the sounding directions is improved.

In S320, direction sense reconstruction is performed on the to-be-processed audio according to a direction sense reconstruction filter corresponding to the target sounding direction to obtain target audio.

In S330, the target audio is output.

According to the technical solution of the embodiment of the present disclosure, different sounding directions are allocated according to the identification information of the target participant. In this manner, each participant can be quickly and accurately allocated a sounding direction, and the efficiency of the selection and allocation of the sounding direction is improved, laying the foundation for the direction sense reconstruction of the sounding of the participant.

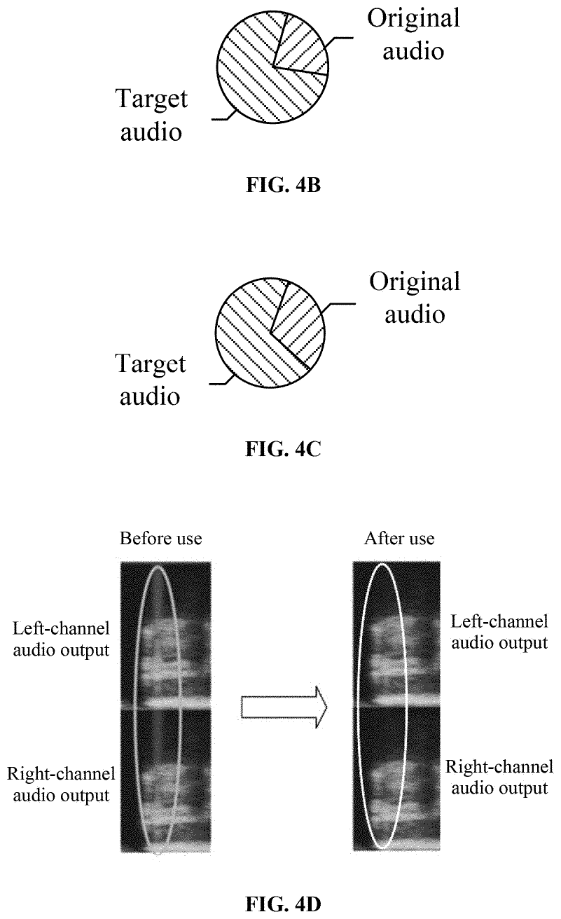

FIG. 4A is a diagram of an audio processing method according to an embodiment of the present disclosure. Preferably, based on the preceding implementations, the embodiment of the present disclosure provides an implementation by taking the participation in an online meeting as an example.

As shown in FIG. 4A, the audio processing method may include four stages, that is, an energy determination stage, a direction allocation stage, a direction sense reconstruction stage and a room reverberation stage.

Exemplarily, the energy determination stage may include steps described below. Multichannel original audio is acquired; whether the energy of the original audio during a set time period is greater than a preset energy value is determined; if the energy of the original audio during the set time period is greater than the preset energy value, the corresponding original audio is determined as to-be-processed audio, and the output side of the to-be-processed audio is taken as a target participant. The energy determination may be implemented using at least one manner in the related art, which is not limited in the present disclosure. The preset energy value and the set time period may be an empirical value or a trial value.

Exemplarily, the direction allocation stage may include the step described below. A target sounding direction is allocated to the target participant from preset sounding directions according to identification information of the target participant.

Optionally, if the number of current allocated sounding directions is less than the total number of the preset sounding directions, the target sounding direction is selected from unallocated preset sounding directions according to the rank of the target participant in the sounding order and in the manner of first middle and then two sides from the preset sounding directions.

Optionally, if the number of current allocated sounding directions is not less than the total number of the preset sounding directions, a hash value of the identification information of the target participant is determined; after the hash value is converted into a numerical value, the total number of the preset sounding directions is divided by the numerical value to obtain a remainder; the target sounding direction is selected from allocated preset sounding directions according to the remainder.

It is to be understood that the hash value of the identification of the target participant is introduced to select the target sounding direction, so that in the case where the number of current allocated sounding directions is not less than the total number of the preset sounding directions, the same target participant is allocated the same preset sounding direction when outputting the to-be-processed audio during different time periods (such as re-accessing the meeting after exiting), thus avoiding the illusion that the position of the target participant changes generated due to different preset sounding directions allocated to the same target participant during different time periods.

To avoid the illusion that the position of the same target participant changes generated due to different preset sounding directions allocated to the same target participant during different time periods in the case where the number of current allocated sounding directions is less than the total number of the preset sounding directions, when the number of current allocated sounding directions is less than the total number of the preset sounding directions, identification information of participants allocated various preset sounding directions may be recorded. Subsequently, when the target participant is allocated the preset sounding direction, if a corresponding relationship between the target participant and the preset sounding direction is recorded, the pre-allocated preset sounding direction is taken as the target sounding direction of the target participant; if no corresponding relationship between the target participant and the preset sounding direction is recorded, the target sounding direction is selected from unallocated preset sounding directions according to the rank of the target participant in the sounding order and in the manner of first middle and then two sides from the preset sounding directions, and the corresponding relationship between the target participant and the preset sounding direction is recorded for subsequent direction allocation.

Exemplarily, the direction sense reconstruction stage may include the step described below. Direction sense reconstruction is performed on the to-be-processed audio according to an HRTF filter corresponding to the target sounding direction to obtain target audio.

Optionally, a target filter coefficient of the HRTF filter corresponding to the target sounding direction may be obtained in the manner described below. Multiple initial filter coefficients in the target sounding direction are acquired from a public HRTF data set; a weighted mean of the multiple initial filter coefficients is calculated to obtain a reference filter coefficient; according to the difference between spectral data corresponding to the reference filter coefficient and standard spectral data obtained statistically under different frequency bands, dynamic Equalizer (EQ) adjustment is performed on the reference filter coefficient to obtain the target filter coefficient. Different initial filtering coefficients correspond to different human head structures.

The HRTF filter involves two parts, that is, left-channel filtering (HRTF_LEFT) and right-channel filtering (HRTF_RIGHT). The filter may be implemented by software and/or hardware.

Exemplarily, the room reverberation stage may include steps described below. Reverberation processing is performed on the target audio based on a Feedback Delay Network (FDN) to update the target audio; the updated target audio is sent to other participants as to-be-output audio.

Different sides of rooms, that is, different total numbers of preset sounding directions, may correspond to the same or different delay levels of the FDN. Generally, the greater the total number of preset sounding directions, that is, the larger the room, the higher the corresponding delay level.

Based on the preceding technical solutions, different participation modes, including a meeting mode and a normal mode, may be preset for selection by users. In the meeting mode, the audio processing method shown in FIG. 4 is used. In the normal mode, after the to-be-processed audio of the target participant is determined, the to-be-processed audio is directly sent to other participants as the to-be-output audio.

In an optional embodiment, effect evaluation may be performed on the original audio and the target audio of the present disclosure in the ABX subjective tone quality test manner from the dimensions of the space sense and the personal preference.

In a specific test process, multiple groups of audio pairs (the original audio and the target audio corresponding to the original audio) are provided, a large number of users participating in the test select the audio having the relatively strong space sense and the audio of the personal preference, and thus a comparison diagram of space sense test results shown in FIG. 4B and a comparison diagram of personal preference test results shown in FIG. 4C are obtained. It can be seen from FIG. 4B that in the space sense dimension, the proportion of selecting the target audio is significantly higher than the proportion of selecting the original audio. It can be seen from FIG. 4C that in the personal preference dimension, the proportion of selecting the target audio is higher than the proportion of selecting the original audio. In summary, the test results of the target audio obtained by processing the original audio in the manner in the present disclosure are better in both the space sense dimension and the personal preference dimension.

To improve the fluency of the audio output process in the mode switching process, after the to-be-output audio is generated, the to-be-output audio may further be cached in a preset cache region. In response to a mode switching operation, the to-be-output audio cached in the preset cache region is output first, and then the switched talk mode is used for determining and outputting new to-be-output audio. The to-be-output audio includes the left-channel audio output and the right-channel audio output.

Referring to a diagram of FIG. 4D showing the tone quality spectrum before a cache manner is used and the tone quality spectrum after the cache manner is used in the mode switching condition, it can be seen that when the cache manner is not used, sound discontinuity (the region circled in the figure) occurs both in the left-channel audio output and the right-channel audio output. Through the manner of introducing the cache, the transition of the left-channel audio output and the right-channel audio output is smoother, which enhances the auditory experience of users.

For the implementation of the preceding various audio processing methods, the present disclosure further provides an optional embodiment of an execution apparatus for implementing the audio processing methods. The embodiment is applicable to performing processing on audio of participants in a case of online communication (such as online meetings or group chats). The apparatus is configured in an electronic device and is capable of implementing the audio processing method in any embodiment of the present disclosure. Further, the audio processing apparatus 500 shown in FIG. 5 specifically includes a direction determination module 510, a direction sense reconstruction module 520 and an audio output module 530.

The direction determination module 510 is configured to in response to receiving to-be-processed audio, determine a target sounding direction corresponding to the to-be-processed audio.

The direction sense reconstruction module 520 is configured to perform, according to a direction sense reconstruction filter corresponding to the target sounding direction, direction sense reconstruction on the to-be-processed audio to obtain target audio.

The audio output module 530 is configured to output the target audio.

In the technical solution of the embodiment of the present disclosure, the sounding direction of a target participant is determined, and then the direction sense reconstruction is performed on the audio, so that the target audio heard by other participants has the direction sense. Therefore, the effect of simulating offline communication is achieved, and the immersive online communication experience is improved.

In an optional implementation, the apparatus further includes a target filter coefficient determination module. The target filter coefficient determination module is configured to determine a target filter coefficient of the direction sense reconstruction filter corresponding to the target sounding direction and specifically includes an initial filter coefficient acquisition unit and a target filter coefficient determination unit.

The initial filter coefficient acquisition unit is configured to acquire at least one initial filter coefficient in the target sounding direction.

The target filter coefficient determination unit is configured to determine the target filter coefficient according to the at least one initial filter coefficient.

In an optional implementation, the target filter coefficient determination unit includes a filter weighting subunit and a target filter coefficient determination subunit.

The filter weighting subunit is configured to weight the at least one initial filter coefficient to obtain a reference filter coefficient.

The target filter coefficient determination subunit is configured to determine the target filter coefficient according to the reference filter coefficient.

In an optional implementation, the target filter coefficient determination subunit includes a filter coefficient adjustment slave unit.

The filter coefficient adjustment slave unit is configured to adjust, according to spectral data of the direction sense reconstruction filter corresponding to the reference filter coefficient, the reference filter coefficient to obtain the target filter coefficient.

In an optional implementation, the direction determination module 510 includes a target sounding direction determination unit.

The target sounding direction determination unit is configured to in response to receiving the to-be-processed audio, determine the target sounding direction according to identification information of a target participant corresponding to the to-be-processed audio.

In an optional implementation, the target sounding direction determination unit includes a direction allocation determination subunit and a sounding direction allocation subunit.

The direction allocation determination subunit is configured to determine, according to the identification information of the target participant corresponding to the to-be-processed audio, whether the target participant is allocated a sounding direction.

The sounding direction allocation subunit is configured to in a case where the target participant is not allocated a sounding direction, allocate the target sounding direction to the target participant according to an existence condition of at least one to-be-allocated sounding direction.

In an optional implementation, the sounding direction allocation subunit includes a direction allocation repeating slave unit.

The direction allocation repeating slave unit is configured to in a case where no to-be-allocated sounding direction exists, select the target sounding direction from at least one allocated sounding direction according to the identification information of the target participant.

In an optional implementation, the sounding direction allocation subunit includes a sounding direction selection slave unit.

The sounding direction selection slave unit is configured to in a case where the at least one to-be-allocated sounding direction exists, select the target sounding direction from the at least one to-be-allocated sounding direction according to a rank of the target participant in a sounding order.

In an optional implementation, the direction allocation repeating slave unit includes a hash value determination slave subunit, an allocation reference data slave subunit and an identification information determination slave subunit.

The hash value determination slave subunit is configured to determine a hash value of the identification information of the target participant.

The allocation reference data slave subunit is configured to perform numerical conversion on the hash value to obtain allocation reference data.

The identification information determination slave subunit is configured to determine identification information of the target sounding direction according to the allocation reference data and the number of preset sounding directions.

In an optional implementation, the audio processing apparatus further includes an audio cache module and a cached audio output module.

The audio cache module is configured to cache to-be-output audio in a preset cache region, where the to-be-output audio is the target audio in an immersive mode or the to-be-processed audio in a normal mode.

The cached audio output module is configured to in response to a mode switching operation, output the to-be-output audio in the preset cache region.

In an optional implementation, the audio processing apparatus further includes a target audio update module.

The target audio update module is configured to, before the target audio is output, perform room reverberation on the target audio to update the target audio.

The audio processing apparatus provided by the embodiment of the present disclosure can execute the audio processing method according to any embodiment of the present disclosure, and has corresponding functional modules for and beneficial effects of executing various audio processing methods.

In the technical solutions of the present disclosure, the collection, storage, use, processing, transmission, provision, and disclosure of the to-be-processed audio and the initial filter coefficient involved are in compliance with provisions of relevant laws and regulations and do not violate public order and good customs.

According to the embodiments of the present disclosure, the present disclosure further provides an electronic device, a readable storage medium, and a computer program product.

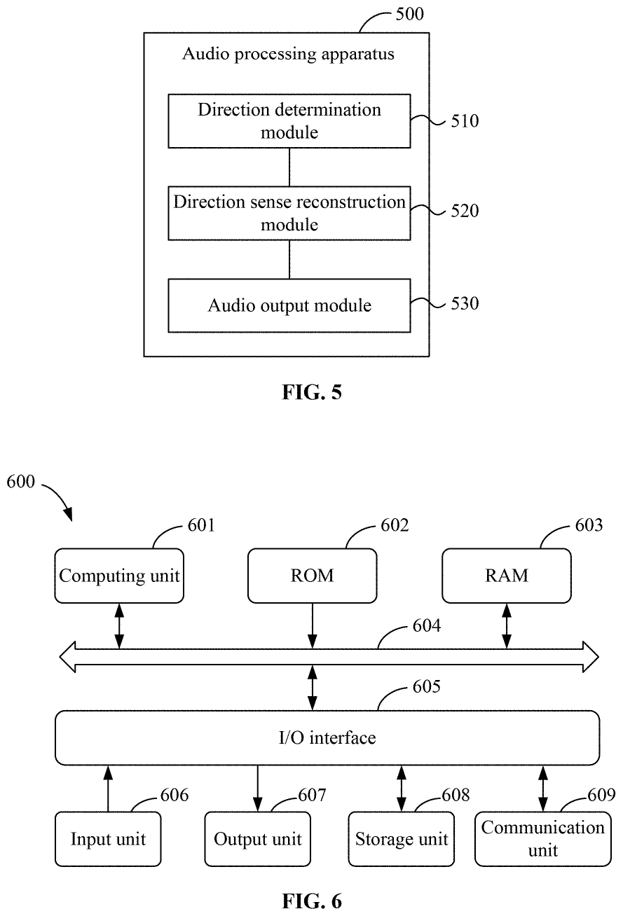

FIG. 6 is a block diagram of an exemplary electronic device 600 that may be configured to implement the embodiments of the present disclosure. Electronic devices are intended to represent various forms of digital computers, for example, a laptop computer, a desktop computer, a worktable, a personal digital assistant, a server, a blade server, a mainframe computer or another applicable computer. Electronic devices may further represent various forms of mobile apparatuses, for example, personal digital assistants, cellphones, smartphones, wearable devices, and other similar computing apparatuses. Herein the shown components, the connections and relationships between these components, and the functions of these components are illustrative only and are not intended to limit the implementation of the present disclosure as described and/or claimed herein. As shown in FIG. 6, the device 600 includes a computing unit 601. The computing unit 601 may perform various types of appropriate operations and processing based on a computer program stored in a read-only memory (ROM) 602 or a computer program loaded from a storage unit 608 to a random-access memory (RAM) 603. Various programs and data required for operations of the device 600 may also be stored in the RAM 603. The computing unit 601, the ROM 602 and the RAM 603 are connected to each other through a bus 604. An input/output (I/O) interface 605 is also connected to the bus 604.

Multiple components in the device 600 are connected to the I/O interface 605. The components include an input unit 606 such as a keyboard and a mouse, an output unit 607 such as various types of displays and speakers, the storage unit 608 such as a magnetic disk and an optical disc, and a communication unit 609 such as a network card, a modem and a wireless communication transceiver. The communication unit 609 allows the device 600 to exchange information/data with other devices over a computer network such as the Internet and/or various telecommunications networks.

The computing unit 601 may be various general-purpose and/or special-purpose processing components having processing and computing capabilities. Examples of the computing unit 601 include, but are not limited to, a central processing unit (CPU), a graphics processing unit (GPU), a special-purpose artificial intelligence (AI) computing chip, a computing unit executing machine learning models and algorithms, a digital signal processor (DSP) and any appropriate processor, controller and microcontroller. The computing unit 601 executes various methods and processing described above, such as the audio processing method. For example, in some embodiments, the audio processing method may be implemented as computer software programs tangibly contained in a machine-readable medium such as the storage unit 608. In some embodiments, part or all of computer programs may be loaded and/or installed on the device 600 via the ROM 602 and/or the communication unit 609. When the computer programs are loaded to the RAM 603 and executed by the computing unit 601, one or more steps of the preceding audio processing method may be executed. Alternatively, in other embodiments, the computing unit 601 may be configured, in any other suitable manner (for example, by means of firmware), to perform the audio processing method described above.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting the data and instructions to the memory system, the at least one input apparatus, and the at least one output apparatus.

Program codes for implementation of the methods of the present disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed entirely on a machine, partly on a machine, as a stand-alone software package, partly on a machine and partly on a remote machine, or entirely on a remote machine or a server.

In the context of the present disclosure, a machine-readable medium may be a tangible medium that may include or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination thereof

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS). The server may also be a server of a distributed system, or a server combined with a blockchain.

Artificial intelligence is the study of making computers simulate certain human thinking processes and intelligent behaviors (such as learning, reasoning, thinking and planning) both at the hardware and software levels. Artificial intelligence hardware technologies generally include technologies such as sensors, special-purpose artificial intelligence chips, cloud computing, distributed storage and big data processing. Artificial intelligence software technologies mainly include several major technologies such as computer vision technologies, speech recognition technologies, natural language processing technologies, machine learning/deep learning technologies, big data processing technologies and knowledge mapping technologies.

It is to be understood that various forms of the preceding flows may be used with steps reordered, added, or removed. For example, the steps described in the present disclosure may be executed in parallel, in sequence or in a different order as long as the desired result of the technical solutions provided in the present disclosure is achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement and the like made within the spirit and principle of the present disclosure falls within the scope of the present disclosure.

What is claimed is:

1. An audio processing method, comprising:
in response to receiving to-be-processed audio, determining a target sounding direction corresponding to the to-be-processed audio;
performing, according to a direction sense reconstruction filter corresponding to the target sounding direction, direction sense reconstruction on the to-be-processed audio to obtain target audio; and
outputting the target audio.

2. The method according to claim 1, wherein a target filter coefficient of the direction sense reconstruction filter corresponding to the target sounding direction is determined in the following manner:
acquiring at least one initial filter coefficient in the target sounding direction; and
determining the target filter coefficient according to the at least one initial filter coefficient.

3. The method according to claim 2, wherein determining the target filter coefficient according to the at least one initial filter coefficient comprises:
weighting the at least one initial filter coefficient to obtain a reference filter coefficient; and
determining the target filter coefficient according to the reference filter coefficient.

4. The method according to claim 3, wherein determining the target filter coefficient according to the reference filter coefficient comprises:
adjusting, according to spectral data of the direction sense reconstruction filter corresponding to the reference filter coefficient, the reference filter coefficient to obtain the target filter coefficient.

5. The method according to claim 1, in response to receiving the to-be-processed audio, determining the target sounding direction corresponding to the to-be-processed audio comprises:
in response to receiving the to-be-processed audio, determining the target sounding direction according to identification information of a target participant corresponding to the to-be-processed audio.

6. The method according to claim 5, wherein determining the target sounding direction according to the identification information of the target participant corresponding to the to-be-processed audio comprises:
determining, according to the identification information of the target participant corresponding to the to-be-processed audio, whether the target participant is allocated a sounding direction; and
in a case where the target participant is not allocated a sounding direction, allocating the target sounding direction to the target participant according to an existence condition of at least one to-be-allocated sounding direction.

7. The method according to claim 6, wherein allocating the target sounding direction to the target participant according to the existence condition of the at least one to-be-allocated sounding direction comprises:
in a case where no to-be-allocated sounding direction exists, selecting the target sounding direction from at least one allocated sounding direction according to the identification information of the target participant.

8. The method according to claim 6, wherein allocating the target sounding direction to the target participant according to the existence condition of the at least one to-be-allocated sounding direction comprises:
in a case where the at least one to-be-allocated sounding direction exists, selecting the target sounding direction from the at least one to-be-allocated sounding direction according to a rank of the target participant in a sounding order.

9. The method according to claim 7, wherein selecting the target sounding direction from the at least one allocated sounding direction according to the identification information of the target participant comprises:
determining a hash value of the identification information of the target participant;
performing numerical conversion on the hash value to obtain allocation reference data; and
determining identification information of the target sounding direction according to the allocation reference data and a number of preset sounding directions.

10. The method according to claim 1, further comprising:
caching to-be-output audio in a preset cache region, wherein the to-be-output audio is the target audio in an immersive mode or the to-be-processed audio in a normal mode; and
in response to a mode switching operation, outputting the to-be-output audio in the preset cache region.

11. The method according to claim 1, before outputting the target audio, the method further comprising:
performing room reverberation on the target audio to update the target audio.

12. An audio processing apparatus, comprising: at least one processor; and a memory communicatively connected to the at least one processor;
wherein the memory stores instructions executable by the at least one processor, and the instructions are executed by the at least one processor to cause the at least one processor to perform steps in the following modules:
a direction determination module configured to in response to receiving to-be-processed audio, determine a target sounding direction corresponding to the to-be-processed audio;
a direction sense reconstruction module configured to perform, according to a direction sense reconstruction filter corresponding to the target sounding direction, direction sense reconstruction on the to-be-processed audio to obtain target audio; and
an audio output module configured to output the target audio.

13. The apparatus according to claim 12, further comprising a target filter coefficient determination module configured to determine a target filter coefficient of the direction sense reconstruction filter corresponding to the target sounding direction and specifically comprising:
an initial filter coefficient acquisition unit configured to acquire at least one initial filter coefficient in the target sounding direction; and
a target filter coefficient determination unit configured to determine the target filter coefficient according to the at least one initial filter coefficient.

14. The apparatus according to claim 13, wherein the target filter coefficient determination unit comprises:
a filter weighting subunit configured to weight the at least one initial filter coefficient to obtain a reference filter coefficient; and
a target filter coefficient determination subunit configured to determine the target filter coefficient according to the reference filter coefficient.

15. The apparatus according to claim 14, wherein the target filter coefficient determination subunit comprises:
a filter coefficient adjustment slave unit configured to adjust, according to spectral data of the direction sense reconstruction filter corresponding to the reference filter coefficient, the reference filter coefficient to obtain the target filter coefficient.

16. The apparatus according to claim 12, wherein the direction determination module comprises:
a target sounding direction determination unit configured to in response to receiving the to-be-processed audio, determine the target sounding direction according to identification information of a target participant corresponding to the to-be-processed audio.

17. The apparatus according to claim 16, wherein the target sounding direction determination unit comprises:
a direction allocation determination subunit configured to determine, according to the identification information of the target participant corresponding to the to-be-processed audio, whether the target participant is allocated a sounding direction; and
a sounding direction allocation subunit configured to in a case where the target participant is not allocated a sounding direction, allocate the target sounding direction to the target participant according to an existence condition of at least one to-be-allocated sounding direction.

18. The apparatus according to claim 17, wherein the sounding direction allocation subunit comprises:
a direction allocation repeating slave unit configured to in a case where no to-be-allocated sounding direction exists, select the target sounding direction from at least one allocated sounding direction according to the identification information of the target participant.

19. The apparatus according to claim 17, wherein the sounding direction allocation subunit comprises:
a sounding direction selection slave unit configured to in a case where the at least one to-be-allocated sounding direction exists, selecting the target sounding direction from the at least one to-be-allocated sounding direction according to a rank of the target participant in a sounding order.

20. A non-transitory computer-readable storage medium storing computer instructions for causing a computer to execute the following steps:
in response to receiving to-be-processed audio, determining a target sounding direction corresponding to the to-be-processed audio;
performing, according to a direction sense reconstruction filter corresponding to the target sounding direction, direction sense reconstruction on the to-be-processed audio to obtain target audio; and
outputting the target audio.
